(19) United States
(12) Patent Application Publication
(10) Pub. No.: US 2025/0282377 A1
(43) Pub. Date: Sep. 11, 2025

(54) SYSTEMS FOR OBJECT DETECTION

(71) Applicant: QUALCOMM Incorporated, San Diego, CA (US)

(72) Inventors: Meda-Alexandra LAZAR, Lugoj (RO); Varun RAVI KUMAR, San Diego, CA (US); Senthil Kumar YOGAMANI, Headford (IE)

(21) Appl. No.: 18/601,870

(22) Filed: Mar. 11, 2024

(51) Int. Cl. B60W 60/00; G01C 21/30; G06T 7/73; G06T 17/05; G06V 20/58; G06V 20/64

(52) U.S. Cl. CPC B60W 60/001; G01C 21/30; G06T 7/73; G06T 17/05; G06V 20/58; G06V 20/64; B60W 2420/403; B60W 2420/408; B60W 2554/00; G06T 2207/10028; G06T 2207/20081; G06T 2207/20084; G06T 2207/30252

(57) ABSTRACT

Systems and techniques are described for object detection. For example, a device can obtain point cloud data of an environment of a device. The point cloud data includes point cloud(s) obtained using sensor(s) and a respective field of view of each sensor. The device can obtain, from camera sensor(s), camera data of the environment. Each camera sensor includes a respective field of view, where a respective vertical field of view of each camera sensor is greater than a respective vertical field of view of each sensor. The device can obtain map data of the environment that includes one or more spatial priors indicative of at least one of elevated object patterns or locations. The device can determine, using a trained machine learning system, a location of an object based on the point cloud data, the camera data, and the map data.

### FIELD

The present disclosure generally relates to object detection. For example, aspects of the present disclosure relate to a system that integrates or fuses point cloud data, camera data, and in some cases map data of a scene or environment to perform object detection (e.g., elevated object detection) in the scene or environment.

### BACKGROUND

Many devices can capture a representation of a scene by generating sensor data (e.g., image data such as images or image frames) of the scene. For example, a camera or a device including a camera can capture a sequence of frames of a scene (e.g., a video of a scene). In some cases, the sensor data can be processed for performing one or more functions, can be output for display, can be output for processing and/or consumption by other devices, among other uses. For instance, sensor data can be processed to perform object detection of one or more objects in the scene.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for object detection. According to at least one example, an apparatus of detecting one or more objects. The apparatus includes at least one memory and at least one processor coupled to the at least one memory and configured to: obtain point cloud data of an environment of the apparatus, the point cloud data comprising one or more point clouds obtained using one or more sensors and a respective field of view of each sensor of the one or more sensors; obtain, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors; obtain map data of the environment, the map data comprising one or more spatial priors indicative of at least one of elevated object patterns or locations; and determine, using a trained machine learning system, a location of an object based on the point cloud data, the camera data, and the map data of the environment of the apparatus.

In another illustrative example, a method of detecting one or more objects at a device is provided. The method includes: obtaining point cloud data of an environment of the device, the point cloud data comprising one or more point clouds obtained using one or more sensors and a respective field of view of each sensor of the one or more sensors; obtaining, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors; obtaining map data of the environment, the map data comprising one or more spatial priors indicative of at least one of elevated object patterns or locations; and determining, using a trained machine learning system, a location of an object based on the point cloud data, the camera data, and the map data of the environment of the device.

In another illustrative example, a non-transitory computer-readable medium of a device is provided having stored thereon instructions that, when executed by one or more processors, cause the one or more processors to: obtain point cloud data of an environment of the apparatus, the point cloud data comprising one or more point clouds obtained using one or more sensors and a respective field of view of each sensor of the one or more sensors; obtain, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors; obtain map data of the environment, the map data comprising one or more spatial priors indicative of at least one of elevated object patterns or locations; and determine, using a trained machine learning system, a location of an object based on the point cloud data, the camera data, and the map data of the environment of the apparatus.

In another illustrative example, an apparatus is provided that includes: means for obtaining point cloud data of an environment of the apparatus, the point cloud data comprising one or more point clouds obtained using one or more sensors and a respective field of view of each sensor of the one or more sensors; means for obtaining, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors; means for obtaining map data of the environment, the map data comprising one or more spatial priors indicative of at least one of elevated object patterns or locations; and means for determining, using a trained machine learning system, a location of an object based on the point cloud data, the camera data, and the map data of the environment of the apparatus.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described here is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, each apparatus can include an image sensor (e.g., a camera) or multiple image sensors (e.g., multiple cameras) for capturing one or more images. In some aspects, each apparatus includes one or more displays for displaying one or more images, notifications, and/or other displayable data. In some aspects, each apparatus includes one or more speakers, one or more light-emitting devices, and/or one or more microphones. In some aspects, each apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of a vehicle with a sensor suite, according to various aspects of the present disclosure.

FIG. 2 is a diagram illustrating an example system that may include one or more machine-learning model(s) trained to generate one or more output(s) based on source data, according to various aspects of the present disclosure.

FIG. 3 is a block diagram illustrating an example of a deep learning neural network that can be used to implement a Graph Neural Network (GNN), according to various aspects of the present disclosure.

FIG. 4 is a block diagram illustrating an example of a convolutional neural network (CNN), according to various aspects of the present disclosure.

FIG. 5 is a graph illustrating an example of spherical coordinates of an elevated object detected within Light Detection and Ranging (LiDAR) sensor data, according to various aspects of the present disclosure.

FIG. 6 is a diagram illustrating an example of a process for map-integrated graph neural network based object detection, according to various aspects of the present disclosure.

FIG. 7 is a flow diagram illustrating an example of a process for object detection, in accordance with some examples.

FIG. 8 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Effective three-dimensional (3D) object detection can be important for many tasks. For instance, 3D object detection by vehicles (e.g., autonomous or semi-autonomous vehicles) can be important to ensure traffic safety and route planning. In some cases, a system performing 3D object detection (e.g., in vehicles, robotics systems, or other systems) may rely on Light Detection and Ranging (LiDAR) sensors implemented within the system (e.g., a vehicle, a robotics system, or other system). However, one significant limitation of LiDAR sensors is their restricted field of view (FOV). Such a constraint becomes particularly problematic when a system (e.g., a vehicle system) attempts to detect objects that are positioned at higher elevations, such as traffic lights and traffic signs. While the horizontal FOV of LiDAR sensors can extend to 360 degrees, the vertical FOV of LiDAR sensors may be limited (e.g., to 30 to 40 degrees). As a result, it can be challenging to use LiDAR sensor information to detect objects located above the limited vertical FOV range of a LiDAR sensor. For example, such a narrow vertical FOV range can make it difficult for a LiDAR sensor to detect objects located at higher elevations, especially as the system (e.g., the vehicle) moves closer to the objects and the angle of elevation increases. As such, improved systems and techniques for robust 3D object detection of elevated objects can be beneficial.

In one or more aspects, systems, apparatuses, processes (also referred to as methods), and computer-readable media (collectively referred to herein as “systems and techniques”) are described herein for integrating or fusing point cloud data, camera data, and in some cases map data of a scene or environment to perform object detection (e.g., elevated object detection) in the scene or environment. In some aspects, the systems and techniques include a map-integrated machine learning system for object detection. In some cases, a machine learning system used by the systems and techniques can include a graph neural network. For instance, the systems and techniques can provide high definition (HD) map-integrated graph neural networks for robust elevated object detection (e.g., detection of objects that are elevated in a scene, such as a traffic light). In one or more examples, the systems and techniques combine point cloud data (e.g., LiDAR point cloud data), camera data (e.g., camera field of view data), and map data (e.g., HD map priors) into a machine learning system, such as a Graph Neural Network (GNN).

According to some aspects, each node within a graph (e.g., in the GNN) can represent a point in a point cloud (e.g., a LiDAR point cloud) of a scene and can be attributed with spatial features and the sensor field of view. Graph neural networks can then be leveraged to propagate contextual information between nodes informed by a 3D structure of the scene and the sensor field-of-view. Temporal modeling may also be achieved via recurrent connections. Fusing HD map graphs can provide strong spatial priors through alignment. By jointly modeling point cloud data (e.g., LiDAR data), camera data, and maps (e.g., HD maps) as an integrated spatio-temporal graph, the systems and techniques can achieve a robust detection of elevated objects (e.g., traffic lights and traffic signs) by reasoning the 3D relationships and leveraging complementary sensor strengths and map priors.

HD maps can be used by systems to determine characteristics of a scene. For example, HD maps are a fundamental component of many vehicles (e.g., autonomous and/or semi-autonomous vehicles) by encoding prior knowledge of all scenes (e.g., environment) a vehicle may encounter. An HD map may be three-dimensional (e.g., including elevation information). For instance, an HD map may include three-dimensional data (e.g., elevation data) regarding a three-dimensional space, such as a road on which a vehicle is navigating. In some examples, the HD map can include a plurality of map points corresponding to one or more reference locations in the three-dimensional space. In some cases, the HD map can include dimensional information for objects in the three-dimensional space and other semantic information associated with the three-dimensional space. For instance, the information from the HD map can include elevation or height information (e.g., road elevation/height), normal information (e.g., road normal), and/or other semantic information related to a portion (e.g., the road) of the three-dimensional space in which the vehicle is navigating.

An HD map may include a high level of detail (e.g., including centimeter level details). In the context of HD maps, the term “high” typically refers to the level of detail and accuracy of the map data. In some cases, an HD map may have a higher spatial resolution and/or level of detail as compared to a non-HD map. While there is no specific universally accepted quantitative threshold to define “high” in HD maps, several factors contribute to the characterization of the quality and level of detail of an HD map. Some key aspects considered in evaluating the “high” quality of an HD map include resolution, geometric accuracy, semantic information, dynamic data, and coverage. With regard to resolution, HD maps generally have a high spatial resolution, meaning they provide detailed information about the environment. The resolution can be measured in terms of meters per pixel or pixels per meter, indicating the level of detail captured in the map. With regard to geometric accuracy, an accurate representation of road geometry, lane boundaries, and other features can be important in an HD map. High-quality HD maps strive for precise alignment and positioning of objects in the real world. Geometric accuracy is often quantified using metrics such as root mean square error (RMSE) or positional accuracy. With regard to semantic information, HD maps include not only geometric data but also semantic information about the environment. This may include lane-level information, traffic signs, traffic signals, road markings, building footprints, and more. The richness and completeness of the semantic information contribute to the level of detail in the map. With regard to dynamic data, some HD maps incorporate real-time or near real-time updates to capture dynamic elements such as traffic flow, road closures, construction zones, and temporary changes. The frequency and accuracy of dynamic updates can affect the quality of the HD map. With regard to coverage, the extent of coverage provided by an HD map is another important factor. Coverage refers to the geographical area covered by the map. An HD map can cover a significant portion of a city, region, or country. In general, an HD map may exhibit a rich level of detail, accurate representation of the environment, and extensive coverage.

In one or more aspects, the systems and techniques incorporate azimuth, radius, and elevation of point clouds (e.g., LiDAR point clouds), along with the camera FOV and map information (e.g., HD map information), into a trained machine learning system (e.g., a neural network, such as a GNN). Incorporating the azimuth, radius, and elevation of the point clouds provides a comprehensive understanding of the 3D space around the vehicle, and the color information from the camera can be combined with distance measurements from one or more depth sensors (e.g., one or more LiDAR sensors or systems) to create a more robust system for detection of objects located above the FOV of the depth sensors (e.g., LiDAR sensors). In some implementations, the map information (e.g., the HD map information) can include spatial priors that can aid the trained network in learning typical elevated object patterns and locations.

In one or more aspects, during operation of the systems and techniques for detecting an object (e.g., a location of the object) within an environment of a device, point cloud data (e.g., LiDAR data), camera data, and map data of the environment of the device can be inputted into a trained network of the device. The trained network of the device can determine a location of the object, based on the point cloud data (e.g., LiDAR data) a, the camera data, and the map data of the environment of the device.

In one or more examples, one or more sensors (e.g., depth sensors, such as LiDAR sensor(s)) of the device can obtain the point cloud data (e.g., LiDAR data) of the environment of the device. In some examples, one or more camera sensors of the device can obtain the camera data of the environment of the device. In one or more examples, the trained network can be a graph neural network (GNN).

In some examples, the point cloud data can include one or more point clouds (e.g., LiDAR point clouds). In one or more examples, each point cloud of the one or more point clouds (e.g., the LiDAR point cloud(s)) can include an azimuth, radius, and elevation of the object with respect to the device. In some examples, a plurality of graphs can be constructed, where each graph of the plurality of graphs can be associated with a respective point cloud of the one or more point clouds. In one or more examples, each graph of the plurality of graphs can include a plurality of nodes. In some examples, one or more nodes of the plurality of nodes can be pruned based on the one or more nodes being redundant and/or less informative than other nodes of the plurality of nodes with respect to the object.

In one or more examples, the camera data can include a field of view of each camera sensor of one or more camera sensors of the device. In some examples, the point cloud data (e.g., LiDAR point cloud data) can include a field of view of each sensor (e.g., LiDAR sensor) of one or more sensors (e.g., LiDAR sensors) of the device. In one or more examples, the determining of the location of the object can be further based on temporal data of the environment. In some examples, the device can be a vehicle, such as an autonomous vehicle.

The systems and techniques described herein provide a number of benefits. For example, the systems and techniques can provide an enhanced understanding of complex 3D driving scenes by incorporating spatial attributes, like azimuth, elevation, radius into graph representation. The systems and techniques can provide for improved detection of objects at challenging orientations and elevations by fusing LiDAR's spatial precision with a camera's wide field of view. The systems and techniques may also provide for a higher accuracy and robustness to occlusion by leveraging temporal context using recurrent graph networks. The systems and techniques can provide for increased efficiency and accelerated inference by pruning redundant graph content. The systems and techniques can also provide a stronger generalization from integrating map priors and spatial patterns. The systems and techniques may provide attention mechanisms that allow for focusing computational effort on most relevant regions. The systems and techniques may also provide for joint multi-task learning of detecting traffic signs and signals in one model. The systems and techniques can provide spherical projection that generates an enriched representation of 3D space. The systems and techniques may provide for an easier integration with other graph-based perception approaches for unified sensing. As such, key benefits of the systems and techniques include an enhanced 3D scene understanding, sensor fusion, efficiency, generalization, and end-to-end learning for accurate and robust detection of traffic signs and signals.

The object detection systems and techniques described herein can be used for various types of applications, such as vehicle applications (e.g., in an Advanced Driver Assistance Systems (ADAS) system of a vehicle), extended reality (XR) systems, robotics systems (e.g., for autonomous navigation of a robotic device), among others. For example, a device or system implementing the object detection techniques can be part of a vehicle (e.g., an ADAS system of the vehicle). In such an example, the device or system can adjust an operating parameter of the vehicle based on a detected object or multiple detected object (e.g., the location of the object or objects). The operating parameter can be associated with a path for the vehicle to travel (e.g., for path planning of the vehicle trajectory), an automatic braking parameter for operating one or more brakes of the vehicle (e.g., for automatic braking applications), a lane change parameter for causing the vehicle to navigate from a first lane to a second lane (e.g., for lane changing applications), a display parameter associated with a user interface of the vehicle (e.g., displaying an indication of the location of the object via a user interface, such as an interactive display, of the vehicle), among other uses.

Additional aspects of the present disclosure are described in more detail below.

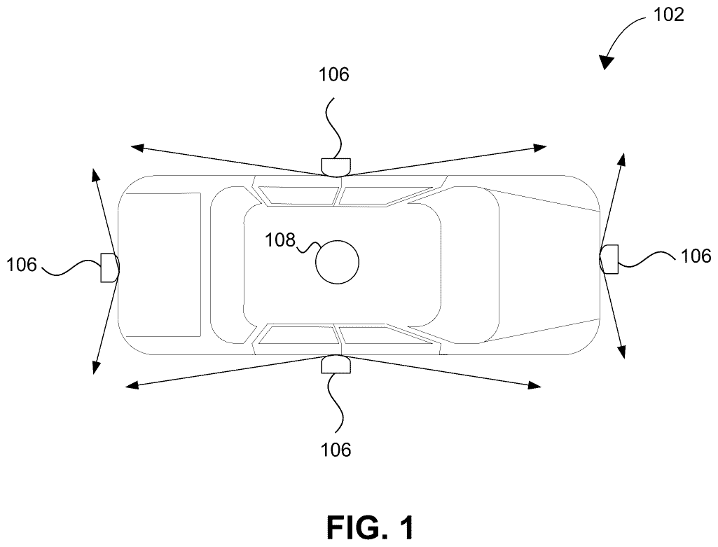

FIG. 1 is a diagram illustrating an example of a vehicle (e.g., an autonomous vehicle) with a sensor suite. In particular, FIG. 1 illustrates a source vehicle 102 (e.g., an autonomous vehicle) including a source sensor suite. The source sensor suite is shown to include four cameras 106 and one Light Detection and Ranging (LiDAR) sensor 108. Each of the cameras 106 may be a surround view (SV) camera or a fisheye camera, for example, with a wide (e.g., nearly 180 degree) field of view. The LiDAR sensor 108 may be a 64-layer LiDAR sensor.

Collectively, the source sensor suite may have certain intrinsic parameters (e.g., focal lengths of the cameras 106, optical centers of the cameras 106, skew coefficients of the cameras 106, frame-capture rates of the cameras 106, scan patterns of the LiDAR sensor 108, and/or intensity channels of the LiDAR sensor 108) and certain extrinsic parameters (e.g., positions of the cameras 106 and the LiDAR sensor 108 on source vehicle 102).

Data from the source sensor suite may be used to train machine-learning models to perform specific tasks such as static three dimensional (3D) and/or bird's eye view (BEV) tasks, for instance: 3D lane detection, 3D object detection (e.g., traffic-light detection, and/or sign detection), and/or static two-dimensional (2D) perspective-view (PV) tasks for instance: image-based lane detection and/or 2D object detection and/or other tasks.

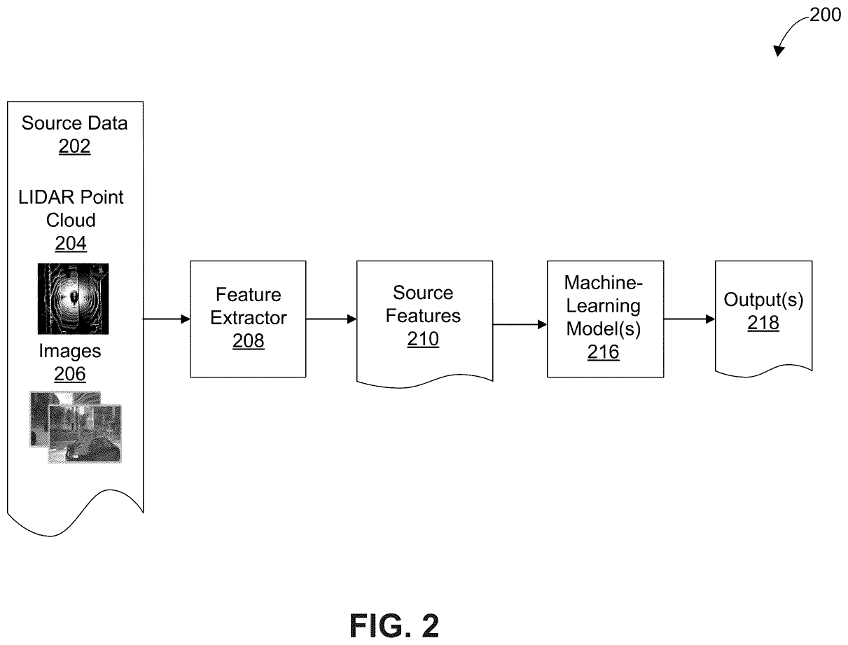

FIG. 2 is a diagram illustrating an example system 200 that may include one or more machine-learning model(s) 216 trained to generate one or more output(s) 218 based on source data 202. The source data 202 may include one or more LiDAR point clouds 204 (e.g., captured by a LiDAR sensor, such as the LiDAR sensor 108 of FIG. 1) and images 206 (e.g., captured by one or more cameras, such as the cameras 106 of FIG. 1). A feature extractor 208 of the system 200 may generate source features 210 based on the source data 202. The system 200 may provide the source features 210 to machine-learning model(s) 216. The machine-learning model(s) 216 may generate output(s) 218 based on the source features 210.

The machine-learning model(s) 216 and/or the feature extractor 208 may be trained using the source data (e.g., data from a sensor suite of a “source” vehicle, such as the source sensor suite of the source vehicle 102). In the present disclosure, the term “source” may refer to one source of data. In the present disclosure, in general, machine-learning models may be trained using source data (which may be captured using a sensor suite of a source vehicle).

The system 200 may be an illustration of machine-learning model(s) 216 operating at an inference stage of operation, for example, processing live source data 202 to generate output(s) 218. The machine-learning model(s) 216 and/or the feature extractor 208 of the system 200 may be trained during a training phase of operation. For example, training source data (e.g., a corpus of source data 202) may be processed by the feature extractor 208 and machine-learning model(s) 216, and the system 200 may generate outputs. The outputs may be compared with ground truth data, and an error may be determined between the performance of the system 200 (e.g., the outputs) and the ground truth data. The machine-learning model(s) 216 and/or the feature extractor 208 may be adjusted, for example, parameters (e.g., weights) of the machine-learning model(s) 216 and/or the feature extractor 208 may be adjusted based to decrease the error in further iterations of the training phase of operations.

The machine-learning model(s) 216 may include any number of related or independent machine-learning models. The machine-learning model(s) 216 may perform tasks related to, for example, object detection and lane detection. The machine-learning model(s) 216 may perform tasks using two-dimensional (2D) techniques and/or three-dimensional (3D) techniques. The machine-learning model(s) 216 may perform tasks which may involve generating output(s) 218. The output(s) 218 may include data (e.g., locations of vehicles or lanes), signals, and/or instructions to other modules.

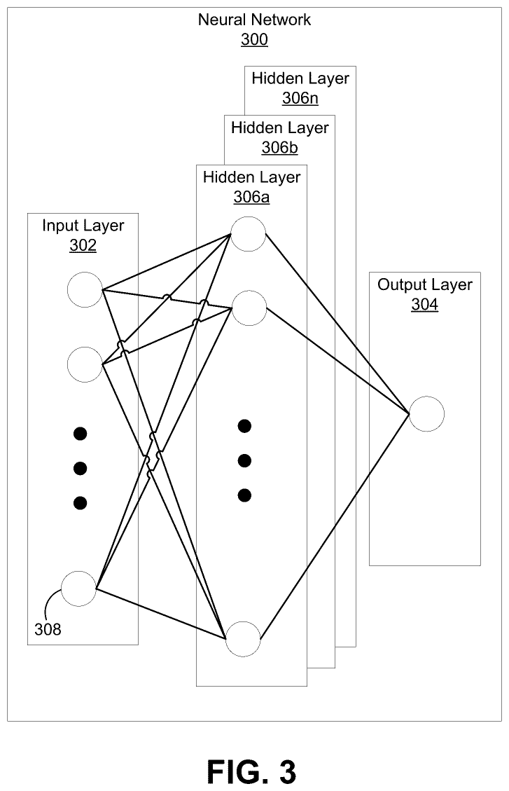

As mentioned, various aspects of the present disclosure can use machine-learning models or systems. FIG. 3 is an illustrative example of a neural network 300 (e.g., a deep-learning neural network) that can be used to implement one or more machine-learning-based tasks, such as object detection, lane detection, alignment, similarity determination, feature segmentation, implicit-neural-representation generation, rendering, classification, image recognition (e.g., face recognition, object recognition, scene recognition, etc.), feature extraction, authentication, gaze detection, gaze prediction, and/or automation. For example, the neural network 300 may be an example of, or can implement, feature extractor 208, machine-learning model(s) 216, and/or GNN 635.

An input layer 302 includes input data. In one illustrative example, the input layer 302 can include data representing source data 202, LiDAR point cloud 204, images 206, source features 210, LiDAR point clouds 620, LiDAR field of view, camera's field of view 625, camera images 640, HD maps 610, graph representation 615, and/or graph representation 630.

The neural network 300 can include multiple hidden layers, such as hidden layers 306a, 306b, through 306n. The hidden layers 306a, 306b through hidden layer 306n include “n” number of hidden layers, where “n” is an integer greater than or equal to one. The number of hidden layers can be made to include as many layers as needed for the given application. The neural network 300 can further include an output layer 304 that provides an output resulting from the processing performed by the hidden layers 306a, 306b through 306n. In one illustrative example, the output layer 304 can provide source features 210, output(s) 218, LiDAR BEV features 650, camera BEV features 660, feature concatenation 665, and/or feature map 675.

The neural network 300 may be, or may include, a multi-layer neural network of interconnected nodes. Each node can represent a piece of information. Information associated with the nodes can be shared among the different layers, and each layer can retain information as the information is processed. In some cases, the neural network 300 can include a feed-forward network, in which case there are no feedback connections where outputs of the network are fed back into itself. In some cases, the neural network 300 can include a recurrent neural network, which can have loops that allow information to be carried across nodes while reading in input.

Information can be exchanged between nodes through node-to-node interconnections between the various layers. The nodes of the input layer 302 can activate a set of nodes in the first hidden layer 306a. For example, as shown, each of the input nodes of the input layer 302 is connected to each of the nodes of the first hidden layer 306a. The nodes of first hidden layer 306a can transform the information of each input node by applying activation functions to the input node information. The information derived from the transformation can then be passed to and can activate the nodes of the next hidden layer 306b, which can perform their own designated functions. Example functions can include convolutional, up-sampling, data transformation, and/or any other suitable functions. The output of the hidden layer 306b can then activate nodes of the next hidden layer, and so on. The output of the last hidden layer 306n can activate one or more nodes of the output layer 304, at which an output is provided. In some cases, while nodes (e.g., node 308) in the neural network 300 are shown as having multiple output lines, a node has a single output and all lines shown as being output from a node represent the same output value.

In some cases, each node or interconnection between nodes can have a weight that is a set of parameters derived from the training of neural network 300. Once the neural network 300 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing the neural network 300 to be adaptive to inputs and able to learn as more and more data is processed.

The neural network 300 may be pre-trained to process the features from the data in the input layer 302 using the different hidden layers 306a, 306b, through 306n in order to provide the output through the output layer 304. In an example in which the neural network 300 is used to identify features in images, the neural network 300 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, the neural network 300 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 300 is trained well enough so that the weights of the layers are accurately tuned.

For the example of identifying objects in images, the forward pass can include passing a training image through the neural network 300. The weights are initially randomized before the neural network 300 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 300, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, the neural network 300 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½(target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 300 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{dL}{dW} ,$$

where w denotes a weight, wᵢ denotes the initial weight, and η denotes a learning rate. The learning rate can be set to any suitable value, with a high learning rate including larger weight updates and a lower value indicating smaller weight updates.

The neural network 300 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 300 can include any other deep network other than a CNN, such as an autoencoder, a deep belief nets (DBNs), a Recurrent Neural Networks (RNNs), among others.

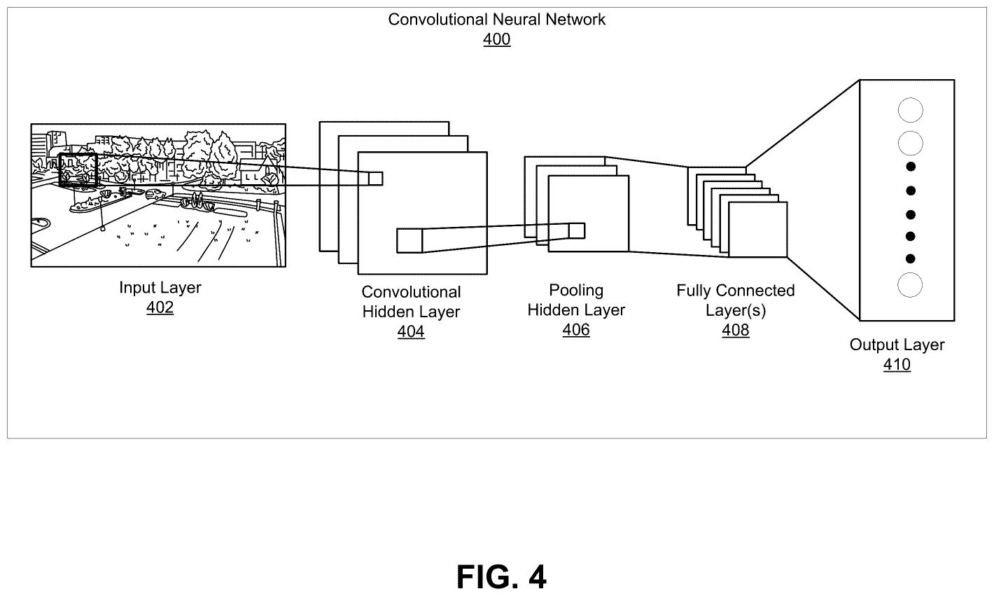

FIG. 4 is an illustrative example of a convolutional neural network (CNN) 400. The input layer 402 of the CNN 400 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 404, an optional non-linear activation layer, a pooling hidden layer 406, and fully connected layer 408 (which fully connected layer 408 can be hidden) to get an output at the output layer 410. While only one of each hidden layer is shown in FIG. 4, one of ordinary skill will appreciate that multiple convolutional hidden layers, non-linear layers, pooling hidden layers, and/or fully connected layers can be included in the CNN 400. As previously described, the output can indicate a single class of an object or can include a probability of classes that best describe the object in the image.

The first layer of the CNN 400 can be the convolutional hidden layer 404. The convolutional hidden layer 404 can analyze image data of the input layer 402. Each node of the convolutional hidden layer 404 is connected to a region of nodes (pixels) of the input image called a receptive field. The convolutional hidden layer 404 can be considered as one or more filters (each filter corresponding to a different activation or feature map), with each convolutional iteration of a filter being a node or neuron of the convolutional hidden layer 404. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 404. Each connection between a node and a receptive field for that node learns a weight and, in some cases, an overall bias such that each node learns to analyze its particular local receptive field in the input image. Each node of the convolutional hidden layer 404 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 404 is due to each node of the convolutional layer being applied to its corresponding receptive field. For example, a filter of the convolutional hidden layer 404 can begin in the top-left corner of the input image array and can convolve around the input image. As noted above, each convolutional iteration of the filter can be considered a node or neuron of the convolutional hidden layer 404. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 404. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 404.

The mapping from the input layer to the convolutional hidden layer 404 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 404 can include several activation maps in order to identify multiple features in an image. The example shown in FIG. 4 includes three activation maps. Using three activation maps, the convolutional hidden layer 404 can detect three different kinds of features, with each feature being detectable across the entire image.

In some examples, a non-linear hidden layer can be applied after the convolutional hidden layer 404. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 400 without affecting the receptive fields of the convolutional hidden layer 404.

The pooling hidden layer 406 can be applied after the convolutional hidden layer 404 (and after the non-linear hidden layer when used). The pooling hidden layer 406 is used to simplify the information in the output from the convolutional hidden layer 404. For example, the pooling hidden layer 406 can take each activation map output from the convolutional hidden layer 404 and generates a condensed activation map (or feature map) using a pooling function. Max-pooling is one example of a function performed by a pooling hidden layer. Other forms of pooling functions be used by the pooling hidden layer 406, such as average pooling, L2-norm pooling, or other suitable pooling functions. A pooling function (e.g., a max-pooling filter, an L2-norm filter, or other suitable pooling filter) is applied to each activation map included in the convolutional hidden layer 404. In the example shown in FIG. 4, three pooling filters are used for the three activation maps in the convolutional hidden layer 404.

In some examples, max-pooling can be used by applying a max-pooling filter (e.g., having a size of 2×2) with a stride (e.g., equal to a dimension of the filter, such as a stride of 2) to an activation map output from the convolutional hidden layer 404. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 404 having a dimension of 24×24 nodes, the output from the pooling hidden layer 406 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 400.

The final layer of connections in the network is a fully-connected layer that connects every node from the pooling hidden layer 406 to every one of the output nodes in the output layer 410. Using the example above, the input layer includes 28×28 nodes encoding the pixel intensities of the input image, the convolutional hidden layer 404 includes 3×24×24 hidden feature nodes based on application of a 5×5 local receptive field (for the filters) to three activation maps, and the pooling hidden layer 406 includes a layer of 3×12×12 hidden feature nodes based on application of max-pooling filter to 2×2 regions across each of the three feature maps. Extending this example, the output layer 410 can include ten output nodes. In such an example, every node of the 3×12×12 pooling hidden layer 406 is connected to every node of the output layer 410.

The fully connected layer 408 can obtain the output of the previous pooling hidden layer 406 (which should represent the activation maps of high-level features) and determines the features that most correlate to a particular class. For example, the fully connected layer 408 can determine the high-level features that most strongly correlate to a particular class and can include weights (nodes) for the high-level features. A product can be computed between the weights of the fully connected layer 408 and the pooling hidden layer 406 to obtain probabilities for the different classes. For example, if the CNN 400 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 410 can include an M-dimensional vector (in the prior example, M=10). M indicates the number of classes that the CNN 400 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

Object detection is one example of a task that can be performed using machine learning systems or models. As previously mentioned, it can be important to perform effective 3D object detection by systems (e.g., autonomous or semi-autonomous vehicles, robotics systems, etc.). For example, effective 3D object detection by a vehicle (e.g., an autonomous or semi-autonomous vehicle) can be important to ensure traffic safety and route planning. In some implementations, 3D object detection can rely on LiDAR sensors implemented within the system performing 3D object detection (e.g., within a vehicle, robotics system, etc.).

However, LiDAR sensors have a restricted FOV, which can become particularly problematic when a system (e.g., a vehicle) attempts to detect objects that are positioned at higher elevations (e.g., traffic lights and traffic signs). For instance, while the horizontal FOV of the LiDAR sensors can be extensive (e.g., extend up to 360 degrees), the vertical FOV of the LiDAR sensors is limited (e.g., from 30 to 40 degrees). Using LiDAR signal information to detect objects located above the limited vertical FOV range can thus be challenging. For example, the narrow vertical range of LiDAR sensors can make it difficult for a system to detect objects located at higher elevations. Such an issue can become more of a challenge as the system (e.g., vehicle) moves closer to the objects and the angle of elevation increases. Therefore, improved systems and techniques for robust 3D object detection of elevated objects can be useful.

As noted previously, systems and techniques are described herein that provide map-integrated machine learning systems or models (e.g., graph neural networks (GNNs)) for robust elevated object detection. In one or more examples, the systems and techniques can combine LiDAR point cloud data, camera field of view data, and HD map priors into a GNN. Each node within a graph (in the GNN) may represent a point in a LiDAR point cloud and may be attributed with spatial features and the sensor field of view. Graph neural networks may then be leveraged to propagate contextual information between nodes informed by the 3D structure and the sensor field-of-view. Temporal modeling can also be achieved via recurrent connections. Fusing HD map graphs can provide strong spatial priors through alignment. By jointly modeling LiDAR data, camera data, and HD maps as an integrated spatio-temporal graph, the systems and techniques can achieve a robust detection of elevated objects (e.g., traffic lights and traffic signs) by reasoning the 3D relationships and leveraging complementary sensor strengths and map priors.

In one or more aspects, the systems and techniques incorporate azimuth, radius, and elevation of LiDAR point clouds, along with the camera FOV and HD map information, into a trained network (e.g., a GNN). Incorporating the azimuth, radius, and elevation of LiDAR point clouds allows for a comprehensive understanding of the 3D space around the vehicle (e.g., autonomous vehicle), and the color information from the camera can be combined with the distance measurements from the LiDAR system to create a more robust system for detection of objects located above the LiDAR FOV (e.g., traffic signs and traffic lights). In some implementations, the HD map information can include spatial priors that can aid the trained network in learning typical elevated object patterns and locations.

In essence, the limited field of view of LiDAR sensors poses a significant challenge to the detection of elevated objects, especially as the ego car (e.g., autonomous vehicle) moves closer to these objects. This limitation could potentially compromise the safety and efficiency of autonomous vehicles, thereby making it a critical issue that needs to be addressed.

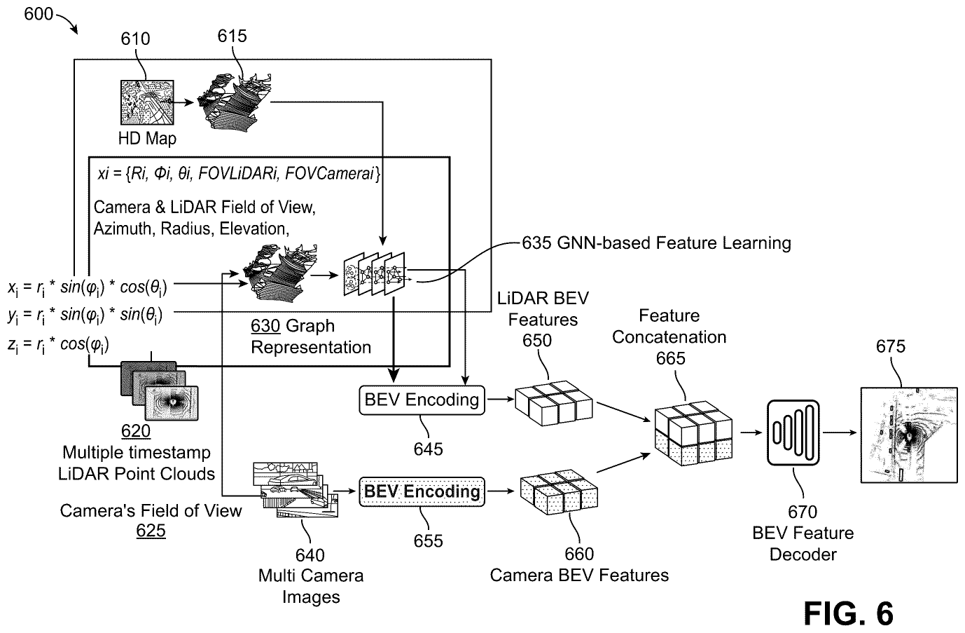

In one or more examples, to address the limitations of LiDAR sensors in detecting elevated objects (e.g., traffic signs and traffic lights), the systems and techniques incorporate the azimuth, radius, and elevation of LiDAR point clouds (e.g., LiDAR point clouds 620 of FIG. 6), along with the camera field of view (e.g., camera field of view 625 of FIG. 6), into a GNN (e.g., GNN 635 of FIG. 6). The azimuth, radius, and elevation of LiDAR point clouds can provide critical information about the spatial distribution of objects in the environment. By incorporating these parameters into the GNN, the model can gain a more comprehensive understanding of the 3D space around the vehicle. This enhanced spatial awareness can significantly improve the model's ability to detect objects at various elevations, including those that are typically challenging for LiDAR sensors to identify due to their limited vertical field of view.

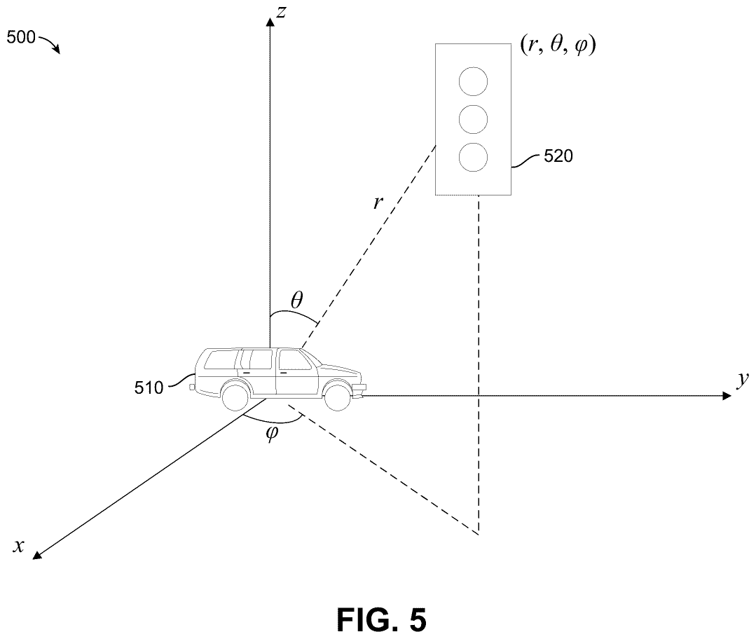

FIG. 5 shows an example of a graph 500 illustrating spherical coordinates (including azimuth (φ), radius (r), and elevation (θ)) of an elevated object 520 relative to a vehicle 510. In some cases, the elevated object 520 may be detected within LiDAR sensor data (e.g., a LiDAR point cloud). The graph 500 of FIG. 5 is shown to have an x-axis, y-axis, and z-axis.

In the graph 500 of FIG. 5, the vehicle 510 (e.g., in the form of an autonomous vehicle) and an elevated object 520 (e.g., in the form of a traffic light) are shown. The vehicle 510 may have one or more LiDAR sensors (e.g., such as LiDAR sensor 108 of FIG. 1) implemented within the vehicle 510. The LiDAR sensors of the vehicle 510 may obtain LiDAR sensor data that may include a detection of the elevated object 520 (e.g., traffic light). The LiDAR sensor data may be in the form of a LiDAR point cloud. Within the LiDAR point cloud, the elevated object 520 is located at an azimuth (φ), radius (r), and elevation (θ) with respect to the vehicle 510. The graph 500 may be constructed from the LiDAR point cloud.

In one or more examples, for the systems and techniques, in addition to the LiDAR data (e.g., LiDAR point clouds 620 of FIG. 6), the camera field of view (e.g., camera field of view 625 of FIG. 6) may also be integrated into the GNN (e.g., GNN 635 of FIG. 6). Cameras offer a wider vertical field of view as compared to LiDAR sensors, making cameras particularly useful for detecting elevated objects. By combining the strengths of both LiDAR and camera data, the GNN can leverage the high-resolution, color information from the camera along with the accurate distance measurements from the LiDAR data to create a more robust and accurate object detection system. The integration of these elements into a GNN can be particularly beneficial as GNNs are designed to model complex systems and relationships. GNNs excel at understanding and modeling intricate 3D scenes, thereby making them an ideal choice for this application. By incorporating the azimuth, radius, elevation, and camera field of view into the GNN, the model's ability to understand and interpret complex 3D environments can be significantly enhanced, which can lead to a more accurate and reliable object detection system that is capable of detecting elevated objects with greater precision and consistency.

In one or more aspects, the systems and techniques can detect elevated objects (e.g., traffic signs and traffic lights) in autonomous driving scenarios by fusing LiDAR point cloud data (e.g., LiDAR point clouds 620 of FIG. 6), camera field of view data (e.g., camera field of view 625 of FIG. 6), and HD map priors (e.g., HD map 610 of FIG. 6) into a GNN (e.g., GNN 635 of FIG. 6). A graph (e.g., graph 500 of FIG. 5) from the LiDAR point cloud can be constructed, where each point in the graph may represent a node and neighboring nodes can be connected with edges. Node features, like radius, azimuth, elevation from LiDAR and camera field-of-view, can be incorporated within the graph.

This constructed graph (e.g., graph 500 of FIG. 5) can then be passed through a GNN architecture (e.g., GNN 635 of FIG. 6) to learn feature representations via message passing between nodes. Spatial context can be aggregated within messages using radius, azimuth, elevation, and the camera FOV can also be incorporated. In one or more examples, the GNN can be converted to a Recurrent GNN (RGNN) with long short-term memory (LSTM)/gated recurrent unit (GRU) units to model temporal dynamics across frames (e.g., image frames).

HD maps can be encoded into a separate graph capturing road topology, intersections, etc. Graph convolutions can be applied to learn spatial features. An HD map graph can be fused with a sensor graph by using an alignment layer. This fusing can provide for a global spatial context. Traffic sign and/or traffic signal (e.g., traffic light) metadata from HD maps can be incorporated into graph node features for regularization. In one or more examples, graph pruning may be introduced as a preprocessing step to focus computation on key areas. Jointly leveraging the complementary strengths of LiDAR sensor data, camera data, map data and graph networks can provide for robust detection of elevated objects. Recurrent connections and HD maps can provide a useful spatio-temporal context to overcome limitations like occlusions. This disclosed integrated framework capitalizes on spatial structure using graphs and incorporates useful temporal cues. As such, the systems and techniques leverage the strengths of LiDAR data, camera data, and HD maps, and combines them in a GNN framework, enhanced with temporal context, HD map attributes, and graph pruning for robust and efficient detection of elevated objects.

In one or more aspects, the systems and techniques, by integrating LiDAR and Camera Data into a GNN with HD maps, can provide a number of advantages. The integration of LiDAR data, camera data, and HD maps into a unified graph representation for detecting elevated objects can provide complementary strengths. Incorporating spatial attributes, like radius, azimuth, elevation, directly into graph message passing can inform a GNN about 3D structure. Introducing a camera field of view into graph nodes can widen the observable context beyond the LiDAR FOV. Converting a GNN to a RGNN with recurrent connections to model temporal dynamics can improve consistency and handles occlusion. The introduction of a graph pruning step based on a significance score for each node can improve efficiency and accuracy by focusing computation on the most informative regions of the 3D scene. Spatio-temporal modeling capabilities using graphs and recurrence can capture complex dynamics.

In some aspects, the systems and techniques, by incorporating HD map priors into a GNN model, can provide a number of benefits. HD maps can be encoded into a graph structure, and graph convolutions can be applied to learn spatial features from the maps. The HD maps can provide detailed spatial information about road topology, lanes, intersections, and traffic, etc., which can aid the model in learning typical elevated object patterns and locations. A sensor graph can be fused with an HD map graph by using alignment to combine a local and global spatial context. Traffic sign and traffic signal metadata from maps can be used to regularize training and leverage strong priors.

FIG. 6 is a diagram illustrating an example of a process 600 for HD map-integrated graph neural networks for robust elevated object detection. During operation of the process 600 of FIG. 6 for detecting an object (e.g., a traffic light) with in an environment of a device (e.g., a vehicle, such as an autonomous vehicle), one or more LiDAR sensors (e.g., LiDAR sensor 108 of FIG. 1) of the device can obtain LiDAR data of the environment of the device. The LiDAR data can include one or more LiDAR point clouds 620 (e.g., obtained with multiple timestamps) and a field of view of each LiDAR sensor of one or more LiDAR sensors of the device. In one or more examples, each LiDAR point cloud of the one or more LiDAR point clouds can include an azimuth, radius, and elevation of the object (e.g., traffic light) with respect to the device (e.g., vehicle).

One or more camera sensors (e.g., cameras 106 of FIG. 1) of the device can obtain camera data of the environment of the device. The camera data can include multiple camera images 640 (e.g., which may include color) and a field of view of each camera sensor of one or more camera sensors of the device (e.g., camera's field of view 625).

In one or more examples, a plurality of graphs (e.g., graph representation 630) can be constructed, where each graph of the plurality of graphs can be associated with a respective LiDAR point cloud of the one or more LiDAR point clouds 620. In one or more examples, each graph of the plurality of graphs (e.g., graph representation 630) can include a plurality of nodes. In some examples, one or more nodes of the plurality of nodes can be pruned based on the one or more nodes being redundant and/or less informative than other nodes of the plurality of nodes with respect to the object.

In one or more examples, the device (e.g., vehicle) may obtain map data of the environment. In some examples, the map data may include one or more HD maps 610 including information regarding the environment. In some examples, a plurality of graphs (e.g., graph representation 615) can be constructed, where each graph of the plurality of graphs can be associated with a respective HD map 610.

In one or more examples, the LiDAR data, the camera data, and the map data of the environment of the device can be inputted into a trained network (e.g., GNN 635) of the device. In some examples, the graph representation 615 (e.g., of the HD maps 610) and the graph representation 630 (e.g., of the LiDAR data and the camera data) can be inputted into the trained network (e.g., GNN 635) of the device. The GNN 635 (e.g., based on the LiDAR data, the camera data, and the map data of the environment) can determine features of the environment, where one or more of the features include a location of the object (e.g., traffic light). In one or more examples, the determining of the features of the environment (e.g., including the location of the object) can be further based on temporal data of the environment.

A bird's eye view (BEV) encoder 645 can extract the LiDAR BEV features 650 from features outputted from the GNN 635. A BEV encoder 655 can extract the camera BEV features 660 from the multiple camera images 640. The LiDAR BEV features 650 and the camera BEV features 660 can be concatenated together to produce a feature concatenation 665. A BEV feature decoder 670 can decode the features from the feature concatenation 665 to generate a feature map 675 of the environment that includes a location of the object (e.g., traffic light).

In one or more aspects, the systems and techniques integrate the field of view of the LiDAR and the camera in the GNN. The goal is to learn a function that maps each node to a new feature representation.

At first, a spherical projection can be applied to the LiDAR point cloud by:

$${x}_{i} = {r}_{i} * sin ( {φ}_{i} ) * cos ( {θ}_{i} ) , {y}_{i} = {r}_{i} * sin ( {φ}_{i} ) * sin ( {θ}_{i} ) \& {z}_{i} = {r}_{i} * cos ( {φ}_{i} )$$

where (r, φ, θ) are the spherical coordinates, and (x, y, z) are Cartesian coordinates. The spherical projection provides a distorted view that can enhance features useful for distinguishing objects based on elevation and radial distance, which can improve detection performance.

The input to the graph can be the LiDAR field of view, the radius, the azimuth, the elevation, and the camera field of view. The camera field of view can be associated with each node in the graph, indicating whether (or not) the node falls within the camera field of view.

The radius can indicate the distance from a reference point and can be represented as Ri. The Azimuth can be the angular position in the horizontal plane for each node. The elevation can be the angular position for each node environments. Similar to the camera field of view, the LiDAR field of view may be represented as an attribute for each node.

In one or more examples, the GNN can take as input a graph G=(V, E), where Vis the set of vertices (nodes), and E is the set of edges connecting the nodes. Each node Vi in V can represent a 3D point in the environment and has associated attributes Xi:

Xi={Ri,Φi,Θi,FOVLiDARi,FOVCamerai}

where Ri is the radius, or distance of the point from the origin, Φi is the azimuth angle, Θi is the elevation angle.

FOVLiDARi can be a binary value (e.g., 0 or 1) indicating whether the point is within the LiDAR FOV, and FOVCamerai can be a binary value (e.g., 0 or 1) indicating whether the point is within the camera FOV.

In one or more examples, the radius Ri may be calculated as: Ri=\sqrt{(x²+y²+z²)}, where (x, y, z) are the 3D coordinates of the point. The azimuth Φi may be calculated as: Φi=tan⁻¹ (y/x). The elevation Θi may be calculated as: Θi=tan⁻¹(z/\sqrt{(x²+y²)}). The reference plane can be considered as the ground. These parameters can provide spatial information about each point's position and orientation in 3D space.

The GNN can operate on this graph by passing messages between the nodes to learn a feature representation for each node. The wider FOVs and spatial attributes can enhance the model's understanding of the 3D scene and ability to detect elevated objects. This understanding can allow the GNN to effectively fuse the LiDAR and camera data for robust 3D object detection.

In one or more examples, the camera field of view can be computed by calculating the horizontal and the vertical field of view. The width of the sensor can be represented by W, the length of the sensor can be represented by L, and the focal length of the lens can be f. The horizontal field of view HFOV can be computed using the sensor's width and the focal length of the lens: CHFOV=2 arctan(W/2f). The vertical field of view VFOV can be computed in a similar manner, using the sensor's height and the focal length of the lens: CVFOV=2 arctan(H/2f).

In one or more examples, in order to compute the horizontal field of view, the minimum and the maximum of the azimuth can be computed and subtracted: LHFOV=θmax−θmin. In order to compute the vertical field of view, the minimum and the maximum of the elevation can be computed and subtracted: LVFOV=φ max−φmin.

The core component of the GNN is message passing between nodes to aggregate neighborhood information. This message passing can be represented mathematically as:

$${h}^{k} + {1}_{i} = Φ ( {h}_{i}^{k} , {m}_{i}^{k} )$$

where hᵢ^{k} can be the feature representation (hidden state) of node i at layer k, Φ can be the neural network update function, and mᵢ^{k} can be the aggregated message from the neighbors of node i at layer k.

The message mᵢ^{k} can be computed as:

$${m}_{i}^{k} = {\sum }_{j ∈ N ( i )} M ( {h}_{i}^{k} , {h}_{j}^{k} , {e}_{ij} )$$

where N(i) can be the set of neighbors of node I, M can be a neural network that computes the message to pass along edge eᵢⱼ, and eᵢⱼ can be the edge connecting nodes i and j.

To incorporate the FOV and spatial attributes, the message function M can be defined as:

$$M ( {h}_{i}^{k} , {h}_{j}^{k} , {e}_{ij} ) = σ ( W 1 [ {h}_{i}^{k} \vert {h}_{j}^{k} \vert {e}_{ij} ] + b 1 )$$

where W1 and b1 may be learnable parameters, σ can be an activation function, | can denote concatenation and eᵢⱼ=[Ri, Rj, Φi, Φj, Θi, Θj, FOVLiDAR, FOVCamera].

By including the radius, azimuth, elevation and FOV attributes in the message computation, the GNN can learn to effectively aggregate spatial and FOV information across neighborhoods to improve detection of objects at various elevations.

In one or more aspects, the breakdown of how the radius, azimuth, elevation, and FOV attributes are incorporated into the message computation in the GNN is as follows. The radius, or distance, Ri of each node i can be included directly in the message computation. This inclusion of the radius can provide a sense of absolute distance, which can aid in estimating the object size and location. As such:

$$M ( {h}_{i}^{k} , {h}_{j}^{k} , {e}_{ij} ) = σ ( {W}_{1} [ {h}_{i}^{k} \vert {h}_{j}^{k} \vert {R}_{i} \vert {R}_{j} \vert … ] )$$

where M can be a message function, hᵢ^{k} can be a hidden state of node i at layer k, hₖ^{k} can be a hidden state of node j at layer k, eᵢⱼ; can be an edge between nodes i and j, σ can be an activation function, W₁ can be a learnable weight matrix, | can be a concatenation operation, Rᵢ can be a radius or distance of node I, and Rⱼ can be a radius or distance of node j.

By including the radius parameters Rᵢ and Rⱼ in the message computation, the GNN can effectively incorporate distance information to improve 3D understanding and object detection.

The azimuth angles Φᵢ and Φⱼ of nodes i and j can be included by:

$$M ( {h}_{i}^{k} , {h}_{j}^{k} , {e}_{ij} ) = σ ( {W}_{1} [ {h}_{i}^{k} \vert {h}_{j}^{k} \vert {Φ}_{i} \vert {Φ}_{j} \vert … ] )$$

By including the azimuth angles Φᵢ and Φⱼ in the message passing, the GNN can aggregate spatial patterns in the horizontal plane to improve detection, especially for elevated objects.

The elevation angles Θi and Θj of nodes i and j can be included by:

$$M ( {h}_{i}^{k} , {h}_{j}^{k} , {e}_{ij} ) = σ ( {W}_{1} [ {h}_{i}^{k} \vert {h}_{j}^{k} \vert {Θ}_{i} \vert {Θ}_{j} \vert … ] )$$

By incorporating the elevation angles Θi and Θj, the GNN can effectively aggregate vertical spatial patterns to enhance detection of elevated objects.

The binary FOV attributes FOVLiDAR and FOVCamera can be included by:

$$M ( {h}_{i}^{k} , {h}_{j}^{k} , {e}_{ij} ) = σ ( W 1 [ {h}_{i}^{k} \vert {h}_{j}^{k} \vert FOVLiDAR \vert FOVCamera \vert … ] )$$

By integrating the FOV information from both sensors, the GNN can learn to combine the strengths of the LiDAR and camera effectively for robust 3D object detection. By incorporating all these spatial attributes into the message passing, the GNN can effectively learn to aggregate 3D patterns and orient itself to detect objects at various elevations and orientations.

Attention coefficients can be computed by using a multi-head self-attention mechanism:

$${α}_{ij} = {\sum }_{k} {W}_{k} \cdot [ {h}_{i} \vert {h}_{j} \vert {ϕ}_{i} \vert {ϕ}_{j} \vert {θ}_{i} \vert {θ}_{j} ]$$

where αᵢⱼ can be an attention coefficient between nodes i and j, Wₖ can be a learned projection matrix for attention head k, and | can denote a concatenation operation. By including the spatial attributes azimuth and elevation, the attention mechanism can focus on the most relevant regions in 3D for detecting elevated objects.

Aggregate messages can be weighted by attention:

$${m}_{i} = {\sum }_{j ∈ 𝒩 ( i )} {α}_{ij} \cdot Message ( {h}_{i} , {h}_{j} , {ϕ}_{i} , {ϕ}_{j} , {θ}_{i} , {θ}_{j} )$$

By weighting messages by the attention coefficients αᵢⱼ, the model can aggregate information from the most relevant neighboring nodes based on the 3D spatial attributes.

Node features can be updated by using LiDAR and camera FOV masking by:

h′ᵢ=GNN(hᵢ,mᵢ,FOVLiDAR,FOVCamera)

Positional encoding can be added to node features based on spatial attributes. This can allow the model to leverage the multi-modal input and spatial properties to selectively focus on the most relevant regions in 3D for detecting elevated objects.

In one or more aspects, the HD map features can provide spatial priors that aid the model in learning typical elevated object patterns and locations, which can boost performance in predictable driving scenarios. In one or more examples, the HD map data can be encoded into a graph structure matching the LiDAR/camera input graph. For example, the road topology can be encoded as graph connectivity, the lane direction and/or width can be encoded as edge attributes, and/or the intersection locations can be encoded as nodes.

The HD map graph can be registered with the input sensor graph. An edge convolution layer can be introduced to align node features between the graphs by:

$${h}_{i}^{k} = {\sum }_{j ∈ N ( i )} ψ ( {h}_{i}^{k} , {h}_{j}^{k} , {e}_{ij}^{k} )$$

where ψ aligns the HD map features with the input graph.

The aligned HD map node features can be then fused into the input graph by:

$${h}_{i}^{k} = [ {h}_{i}^{k} {h}_{i}^{map , k} ]$$

where hᵢ^{k} can be the hidden state of node i at layer k from the input graph, hᵢ^{map,k} can be the hidden state of the corresponding node from the HD map graph, and C can denote the concatenation operation to fuse the input and map features.

The fused graph can then finally be passed through the GNN architecture by:

$${m}_{i}^{k} = {\sum }_{j ∈ N ( i )} M ( {h}_{i}^{k} , {h}_{j}^{k} , {e}_{ij}^{k} ) and {h}^{k} + {1}_{i} = Φ ( {h}_{i}^{k} , {m}_{i}^{k} )$$

In one or more aspects, in addition to encoding the HD map data into a graph matching the input sensor graph, graph convolutions can also be applied directly on the map graph by:

Let Gmap=(Vmap,Emap) be the graph representing the HD map,

where Vmap can be the set of map nodes, and Emap can be the set of edges representing road connections.

A graph convolution operation can be defined on Gmap by:

$${hmap}_{i} = \sum ( j ∈ N ( i ) ) ψ ( {hmap}_{i} , {hmap}_{j} , {emap}_{i} j )$$

where ψ can be a graph convolution function, hmapᵢ can be the feature representation of map node i, and N(i) can represent the neighbors of node i in Gmap. This can allow for the model to directly learn latent spatial features from the topology and connectivity structure of the HD map graph.

The learned map graph features can then be fused with the LiDAR/camera input graph by:

$${h}_{i} = [ {h}_{i} ; h m a {p}_{i} ]$$

where hᵢ can be the hidden state of node i in the input graph, and hmapᵢ can be the corresponding HD map node feature. This can enable the model to leverage complementary spatial context from both the input sensor data as well as the structured HD map priors.

As mentioned, the HD map features extracted from the map graph can be fused with the LiDAR and camera input features using an edge convolution layer. This fusion can enable complementarity between the spatial context from the sensor data and the structured priors from the HD maps.

GNNs on the map graph can be used to the map the spatial context. By aligning and fusing map features into the input graph, the model is able to leverage both sources of spatial knowledge (e.g., the local view from the sensors as well as the global spatial layout from maps), which can provide a more comprehensive spatial representation for detecting elevated objects compared to using either input modality alone. As such, the edge convolution layer is crucial for properly integrating the multi-modal features.

In one or more aspects, traffic sign and/or traffic signal metadata and locations from HD maps can be incorporated into the graph node features. In one or more examples, G=(V,E) can be defined as the input graph built from sensor data, Vmap=V1ₘₐₚ, v2ₘₐₚ, . . . , vkₘₐₚ can be defined as the set of nodes in the HD map graph corresponding to traffic signs and/or traffic signals, and Fₘₐₚ=f1ₘₐₚ, f2ₘₐₚ, . . . , fkₘₐₚ can be defined as the feature vectors for each map node containing metadata like type, position, orientation etc.

The HD map nodes Vₘₐₚ can first be aligned with the input graph G by using an assignment function A such that:

$${V}_{matched} = A ( {V}_{m a {p}^{,}} V )$$

This function can match each HD map node viₘₐₚ to its corresponding node vj in G.

The HD map node features can then be integrated into the input graph by:

$$Foreach {vi}_{m a p} in {V}_{m a p} : vj = {V}_{matched} [ v {i}_{m a p} ]$$

$$fj = C o ncat ( fj , {fi}_{m a p} )$$

where fj can be the original feature of input node vj, and fiₘₐₚ can be the HD map feature of the aligned map node viₘₐₚ. This integration can concatenate the HD map metadata onto the input node features.

The HD map features can also be integrated into the graph convolution operation by:

$${h}_{i}^{k + 1} = φ ( {h}_{i}^{k} , {m}_{i}^{k} , {f}_{i}^{m a p} )$$

where φ can be the graph convolution function, hᵢ^{k} can be the hidden state of node i, mᵢ^{k} can be the aggregated message from neighbors, and fᵢ^{map} can be the HD map feature for node i. By incorporating known semantic labels and positions from the HD maps, the model can learn to selectively focus on areas, such as intersections with traffic lights, and can leverage those strong spatial priors during training and inference, which can provide regularization that improves detection accuracy.

In one or more aspects, node attributes can be added to indicate proximity or membership to intersections, merges, exits, etc., based on HD maps. In one or more examples, binary indicator attributes can be defined for each node, where intersecᵢ can be 1 if node i is part of an intersection or 0 otherwise, mergeᵢ can be 1 if node i is part of a merge point or 0 otherwise, and exitᵢ can be 1 if node i is part of an exit point or 0 otherwise.

The proximity features can be computed, where dist_{intersec}_{ᵢ} can be the distance of node i to the nearest intersection, dist_{merge}_{ᵢ} can be the distance of node i to the nearest merge point, and distₑₓᵢₜ_{ᵢ} can be the distance of node i to the nearest exit point.

These nodal attributes can be incorporated into the graph convolution by:

$${h}_{i}^{k + 1} = φ ( {h}_{i}^{k} , {m}_{i}^{k} , {intersec}_{1} , {merge}_{i} , {exit}_{i} , {dist}_{{intersec}_{i}} , d i s {t}_{{merge}_{i}} , d i s {t}_{e x i {t}_{i}} )$$

where φ can be the graph convolution function and the additional attributes can provide spatial context.

The attributes can be used to weigh the messages by:

$${m}_{i} = {\sum }_{j ∈ N ( i )} a ( i n t e r s e {c}_{i} , interse {c}_{j} ) \cdot M ( {h}_{i ′} , {h}_{j} )$$

where a( ) can compute the attention coefficients based on the intersection attributes to focus on messages from nearby intersections.

The graph attention can then be applied using the attributes by:

$${α}_{i} j = softmax ( Leaky ReLU ( W [ {h}_{i} \vert {h}_{j} \vert {intersec}_{i} \vert interse {c}_{j} ] ) )$$

where LeakyReLU and softmax can apply attention based on intersection membership. By incorporating intersection, merge, and exit point attributes, the model can selectively aggregate spatial context from areas, such as intersections that are most relevant for detecting elevated objects, such as traffic lights, which can provide additional spatial priors from the HD maps.

In one or more aspects, temporal information can be incorporated within the GNN model for detecting elevated objects. Since 3D scenes and object motions have inherent temporal structure and consistency, leveraging this sequential information using recurrent neural architectures can enhance context and can improve the accuracy and robustness of the elevated object detection. The temporal history can provide valuable insights that complement the spatial data. Elevated objects, such as traffic lights, often exhibit consistent motion patterns over time as the ego-vehicle (e.g., autonomous vehicle) approaches them (e.g., the elevated objects). Modeling these temporal dynamics can improve detection accuracy.

Objects may be partially obstructed or poorly visible in some frames, but clearly visible in preceding or following frames. Aggregating information across time can help overcome temporary occlusion. Temporal context can help resolve ambiguities and improve consistency of predictions across frames. For example, an object classified as a traffic light in previous frames is likely still a traffic light in the current frame. Changes in object attributes, such as size, position, and orientation happen smoothly over time. Modeling the evolution of a 3D scene over consecutive frames can provide useful cues. Recurrent models have memory, which can allow for them to integrate long-range temporal patterns, which can aid in tracking objects and making consistent predictions.

In one or more examples, for incorporating temporal information, the GNN can be converted into a Recurrent Graph Neural Network (RGNN) by making the node feature propagation recurrent by:

$${h}^{k} + {1}_{i} = Φ ( {h}_{i}^{k} , {m}_{i}^{k} , {h}_{i}^{k - 1} )$$

where hᵢ^{k-1} can be the hidden state of node i from the previous timestep k−1.

The message function can also become recurrent by:

$${m}_{i}^{k} = {\sum }_{j ∈ N ( i )} M ( {h}_{i}^{k} , {h}_{j}^{k} , {e}_{ij}^{k} , {h}_{i}^{k - 1} , {h}_{j}^{k - 1} )$$

where M can now take in the previous hidden states of nodes i and j.

The edge attributes eᵢⱼ^{k} can include previous timestep edge attributes to add temporal context by:

$${e}_{i j}^{k} = \{ R {i}^{k} , {Ri}^{k - 1} , {Φ i}^{k} , Φ {i}^{k - 1} , … \}$$

The M and Φ functions can be implemented using LSTM or GRU units to capture temporal dynamics. During training, sequences of graphs across consecutive frames can be fed into the model to learn spatio-temporal patterns, which can allow the RGNN to aggregate information not just spatially, but also temporally across frames, thereby enhancing consistency and accuracy for detecting elevated objects.

In one or more aspects, an auxiliary solution can be employed to incorporate HD map priors into the GNN model for detecting elevated objects. As mentioned, HD maps contain detailed spatial information about road topology, lanes, intersections, traffic signs, signals, etc. HD maps can provide strong priors about expected object locations.

In one or more examples, the majority of traffic lights and traffic signs follow predictable placement patterns relative to road geometry. HD maps can capture these patterns well. Known intersection locations can provide strong cues for elevated object presence, as lights are mostly located at intersections. Directionalities of lanes and connectivity encoded in maps can indicate, for example, which sides of the road to focus on for detecting elevated objects.

HD maps can be highly accurate spatial references unaffected by perception noise or occlusion, which can make HD maps reliable priors. HD maps can be consistent across vehicles and environmental conditions. HD maps can provide global spatial context beyond sensor view. HD maps can also help resolve ambiguities and filter out false detections that do not conform to expected spatial layouts.

Prior knowledge can focus computational effort on relevant regions, thereby improving efficiency. Map-guided detection has shown to boost performance of learning-based models by regularizing training. As such, fusing HD map priors into the model can impart global, consistent spatial knowledge that can complement the local view of sensors. This contextual guidance can make detection more accurate and robust.

In one or more examples, a real-time interference oriented approach for deployment may be employed. In one or more examples, graph pruning may be employed where redundant or less informative nodes and edges from the graph may be pruned, as a preprocessing step, to improve efficiency and accuracy.

In one or more examples, for graph pruning, a full graph G=(V, E) from a LiDAR point cloud and camera image can be constructed. A significance score sᵢ for each node i E V in the graph can be calculated based on its feature representation xᵢ by:

$${s}_{i} = σ ( W \cdot {x}_{i} + b )$$

where W and b can be learned parameters, and σ can be an activation function.

A pruning ratio r (e.g., 0.2 to prune 20% of nodes) can be selected. the nodes can then be sorted by significance score, and the bottom r fraction can be pruned by:

$${V}^{′} = Prune ( V , r )$$

The edges between remaining nodes can then be pruned by:

$${E}^{′} = ( i , j ) ∈ E \vert i ∈ {V}^{′} and j ∈ {V}^{′}$$

The pruned graph G′=(V′, E′) can then be constructed. The pruned graph G′ can then be passed through the GNN architecture for feature learning and object detection. Pruning can focus computation on the most informative regions of the 3D scene, thereby improving efficiency and accuracy. The significance scores could also leverage spatial priors to retain important areas.

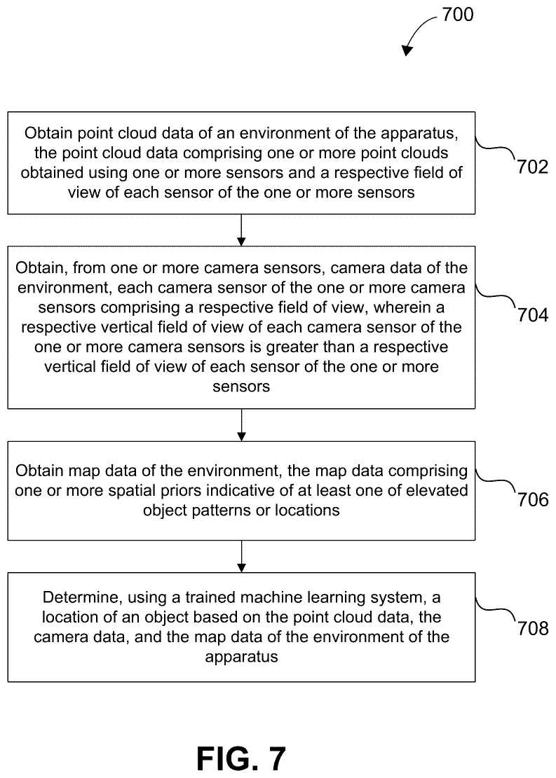

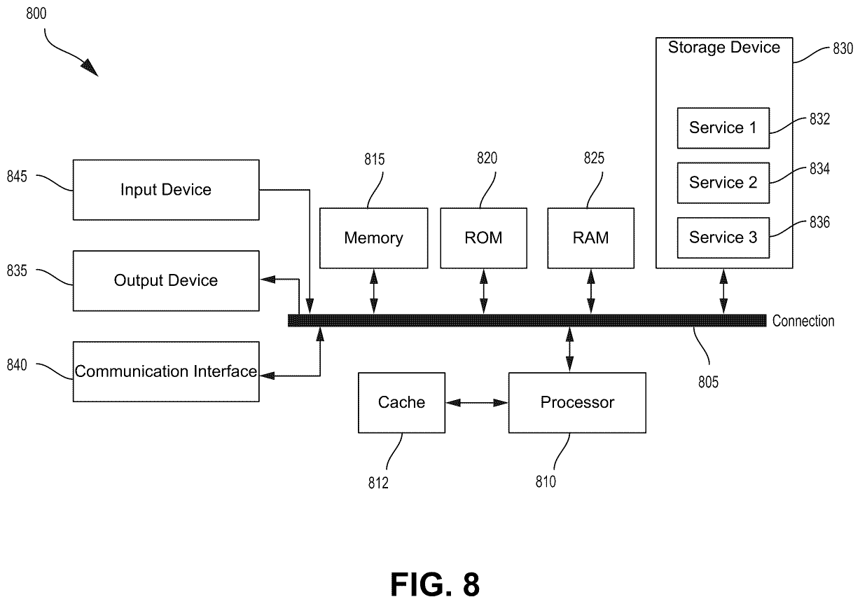

FIG. 7 is a flow chart illustrating an example of a process 700 for object detection. The process 700 can be performed by a computing device (e.g., vehicle 102 of FIG. 1, vehicle 510 of FIG. 5, a computing device or computing system 800 of FIG. 8) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. In some examples, the computing device is a vehicle or is part of (e.g., is a component or system of, such as an Advanced Driver Assistance Systems (ADAS) system) the vehicle. The operations of the process 700 may be implemented as software components that are executed and run on one or more processors (e.g., processor 810 of FIG. 8 or other processor(s)). Further, the transmission and reception of signals by the computing device in the process 700 may be enabled, for example, by one or more antennas and/or one or more transceivers (e.g., wireless transceiver(s)).

At block 702, the computing device (or component thereof) can obtain point cloud data of an environment of the computing device. The point cloud data includes one or more point clouds obtained using one or more sensors (e.g., LiDAR point clouds captured using one or more LiDAR sensors, or other types of point clouds using one or more other types of depth sensors) and a respective field of view of each sensor of the one or more sensors. In some cases, the point cloud data can further include, for each point cloud of the one or more point clouds, a respective azimuth, a respective radius, and a respective elevation of an object with respect to the computing device (e.g., a first azimuth, a first radius, and a first elevation for a first point cloud, a second azimuth, a second radius, and a second elevation for a second point cloud, etc.). In some cases, the computing device includes the one or more sensors, which are configured to capture the one or more point clouds. In some cases, the computing device includes the one or more camera sensors, which are configured to capture the camera data.

At block 704, the computing device (or component thereof) can obtain, from one or more camera sensors, camera data of the environment. Each camera sensor of the one or more camera sensors includes a respective field of view. A respective vertical field of view of each camera sensor of the one or more camera sensors is greater than a respective vertical field of view of each sensor of the one or more sensors. For example, as described above, a camera sensor has a larger vertical field of view as compared to a LiDAR sensor,

At block 706, the computing device (or component thereof) can obtain map data of the environment. As described herein, the map data can include one or more spatial priors indicative of at least one of elevated object patterns or locations.

In some aspects, the computing device (or component thereof) can construct a plurality of graphs. The computing device (or component thereof) can process, using the trained machine learning system, the plurality of graphs to determine the location of the object. In some cases, a graph of the plurality of graphs is associated with a point cloud of the one or more point clouds and is also associated with the camera data. In some examples, the graph is further associated with a field of view of a sensor of the one or more sensors used to capture the point cloud and an azimuth, a radius, and an elevation of the object with respect to the computing device for the point cloud. The graph can further be associated with a field of view of a camera of the one or more camera sensors. For instance, each graph of the plurality of graphs comprises a plurality of nodes. Each node of the plurality of nodes can include a first value (e.g., a binary value) indicating whether a respective azimuth, a respective radius, and a respective elevation of each node is within the respective field of view of each camera sensor of the one or more camera sensors and a second value (e.g., a binary value) indicating whether the respective azimuth, the respective radius, and the respective elevation of each node is within the respective field of view of each sensor of the one or more sensors. In some aspects, the computing device (or component thereof) can prune one or more nodes of the plurality of nodes based on the one or more nodes being at least one of redundant or less informative than other nodes of the plurality of nodes with respect to the object.

At block 708, the computing device (or component thereof) can determine, using a trained machine learning system, a location of an object based on the point cloud data (e.g., the respective azimuth, the respective radius, and the respective elevation of the object with respect to the computing device, or other data as described herein), the camera data, and the map data of the environment of the computing device. In some cases, computing device (or component thereof) can determine the location of the object using the trained machine learning system further based on at least one azimuth (e.g., the azimuth φ described above), at least one respective radius (e.g., the radius r described above), and at least one respective elevation (e.g., the elevation θ described above) of the object with respect to the computing device. In some aspects, the computing device (or component thereof) can determine the location of the object further based on temporal data of the environment. In some aspects, the trained machine learning system can be or can include a graph neural network (GNN). For instance, the trained machine learning system (e.g., a GNN) can process one or more of the plurality of graphs (or pruned graphs), as describe herein.

As noted previously, in some cases the computing device is part of (e.g., is a component or system of, such as an ADAS system) a vehicle. In such cases, the computing device adjust an operating parameter of the vehicle based on the location of the object. For example, the operating parameter can be associated with a path for the vehicle to travel (e.g., for path planning of the vehicle trajectory), an automatic braking parameter for operating one or more brakes of the vehicle (e.g., for automatic braking applications), a lane change parameter for causing the vehicle to navigate from a first lane to a second lane (e.g., for lane changing applications), a display parameter associated with a user interface of the vehicle (e.g., displaying an indication of the location of the object via a user interface, such as an interactive display, of the vehicle), any combination thereof, and/or other applications.

In some cases, the computing device of process 700 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 700 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a block diagram illustrating an example of a computing system 800, which may be employed for HD map-integrated graph neural networks for robust elevated object detection. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 800 includes at least one processing unit (CPU or processor) 810 and connection 805 that communicatively couples various system components including system memory 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800.

Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 840 may also include one or more range sensors (e.g., LiDAR sensors, laser range finders, RF radars, ultrasonic sensors, and infrared (IR) sensors) configured to collect data and provide measurements to processor 810, whereby processor 810 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some aspects, a hardware service that performs a particular function can include the software component stored in a computer-readable medium in connection with the necessary hardware components, such as processor 810, connection 805, output device 835, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus of detecting one or more objects, the apparatus comprising: at least one memory; and at least one processor coupled to the at least one memory and configured to: obtain point cloud data of an environment of the apparatus, the point cloud data comprising one or more point clouds obtained using one or more sensors and a respective field of view of each sensor of the one or more sensors; obtain, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors; obtain map data of the environment, the map data comprising one or more spatial priors indicative of at least one of elevated object patterns or locations; and determine, using a trained machine learning system, a location of an object based on the point cloud data, the camera data, and the map data of the environment of the apparatus.

Aspect 2. The apparatus of Aspect 1, wherein the at least one processor is configured to determine the location of the object using the trained machine learning system based on at least one azimuth, at least one radius, and at least one elevation of the object with respect to the apparatus.

Aspect 3. The apparatus of any of Aspects 1 or 2, wherein the at least one processor is configured to construct a plurality of graphs, wherein a graph of the plurality of graphs is associated with a point cloud of the one or more point clouds and the camera data.

Aspect 4. The apparatus of Aspect 3, wherein the graph is further associated with a field of view of a sensor of the one or more sensors used to capture the point cloud and an azimuth, a radius, and an elevation of the object with respect to the apparatus for the point cloud.

Aspect 5. The apparatus of Aspect 4, wherein the graph is further associated with a field of view of a camera of the one or more camera sensors.

Aspect 6. The apparatus of any of Aspects 3 to 5, wherein each graph of the plurality of graphs comprises a plurality of nodes.

Aspect 7. The apparatus of Aspect 6, wherein the at least one processor is configured to prune one or more nodes of the plurality of nodes based on the one or more nodes being at least one of redundant or less informative than other nodes of the plurality of nodes with respect to the object.

Aspect 8. The apparatus of any of Aspects 6 or 7, wherein each node of the plurality of nodes includes a first value indicating whether a respective azimuth, a respective radius, and a respective elevation of each node is within the respective field of view of each camera sensor of the one or more camera sensors and a second value indicating whether the respective azimuth, the respective radius, and the respective elevation of each node is within the respective field of view of each sensor of the one or more sensors.

Aspect 9. The apparatus of any of Aspects 3 to 8, wherein the at least one processor is configured to process, using the trained machine learning system, the plurality of graphs to determine the location of the object.

Aspect 10. The apparatus of any of Aspects 1 to 9, wherein the at least one processor is configured to determine the location of the object further based on temporal data of the environment.

Aspect 11. The apparatus of any of Aspects 1 to 10, further comprising the one or more sensors, the one or more sensors configured to capture the one or more point clouds.

Aspect 12. The apparatus of any of Aspects 1 to 11, wherein the point cloud data is light detection and ranging (LiDAR) data, and wherein the one or more sensors includes one or more LiDAR sensors.

Aspect 13. The apparatus of any of Aspects 1 to 12, further comprising the one or more camera sensors, the one or more camera sensors configured to capture the camera data.

Aspect 14. The apparatus of any of Aspects 1 to 13, wherein the apparatus is part of a vehicle.

Aspect 15. The apparatus of Aspect 14, wherein the at least one processor is configured to adjust an operating parameter of the vehicle based on the location of the object.

Aspect 16. The apparatus of Aspect 15, wherein the operating parameter is associated with at least one of a path for the vehicle to travel, an automatic braking parameter for operating one or more brakes of the vehicle, a lane change parameter for causing the vehicle to navigate from a first lane to a second lane, or a display parameter associated with a user interface of the vehicle.

Aspect 17. The apparatus of any of Aspects 1 to 16, wherein the trained machine learning system is a graph neural network (GNN).

Aspect 18. A method of detecting one or more objects at a device, the method comprising: obtaining point cloud data of an environment of the device, the point cloud data comprising one or more point clouds obtained using one or more sensors and a respective field of view of each sensor of the one or more sensors; obtaining, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors; obtaining map data of the environment, the map data comprising one or more spatial priors indicative of at least one of elevated object patterns or locations; and determining, using a trained machine learning system, a location of an object based on the point cloud data, the camera data, and the map data of the environment of the device.

Aspect 19. The method of Aspect 18, further comprising determining the location of the object using the trained machine learning system further based on at least one azimuth, at least one respective radius, and at least one respective elevation of the object with respect to the apparatus.

Aspect 20. The method of any of Aspects 18 or 19, further comprising constructing a plurality of graphs, wherein a graph of the plurality of graphs is associated with a point cloud of the one or more point clouds and the camera data.

Aspect 21. The method of Aspect 20, wherein the graph is further associated with a field of view of a sensor of the one or more sensors used to capture the point cloud and an azimuth, a radius, and an elevation of the object with respect to the device for the point cloud.

Aspect 22. The method of Aspect 21, wherein the graph is further associated with a field of view of a camera of the one or more camera sensors.

Aspect 23. The method of any of Aspects 20 to 22, wherein each graph of the plurality of graphs comprises a plurality of nodes.

Aspect 24. The method of Aspect 23, further comprising pruning one or more nodes of the plurality of nodes based on the one or more nodes being at least one of redundant or less informative than other nodes of the plurality of nodes with respect to the object.

Aspect 25. The method of any of Aspects 23 or 24, wherein each node of the plurality of nodes includes a first value indicating whether a respective azimuth, a respective radius, and a respective elevation of each node is within the respective field of view of each camera sensor of the one or more camera sensors and a second value indicating whether the respective azimuth, the respective radius, and the respective elevation of each node is within the respective field of view of each sensor of the one or more sensors.

Aspect 26. The method of any of Aspects 20 to 25, further comprising processing, using the trained machine learning system, the plurality of graphs to determine the location of the object.

Aspect 27. The method of any of Aspects 18 to 26, wherein determining the location of the object is further based on temporal data of the environment.

Aspect 28. The method of any of Aspects 18 to 27, further comprising obtaining, by the one or more sensors of the device, the one or more point clouds.

Aspect 29. The method of any of Aspects 18 to 28, wherein the point cloud data is light detection and ranging (LiDAR) data, and wherein the one or more sensors includes one or more LiDAR sensors.

Aspect 30. The method of any of Aspects 18 to 29, further comprising obtaining, by the one or more camera sensors of the device, the camera data of the environment of the device.

Aspect 31. The method of any of Aspects 18 to 30, wherein the device is a vehicle.

Aspect 32. The method of Aspect 31, further comprising adjusting an operating parameter of the vehicle based on the location of the object.

Aspect 33. The method of Aspect 32, wherein the operating parameter is associated with at least one of a path for the vehicle to travel, an automatic braking parameter for operating one or more brakes of the vehicle, a lane change parameter for causing the vehicle to navigate from a first lane to a second lane, or a display parameter associated with a user interface of the vehicle.

Aspect 34. The method of any of Aspects 18 to 33, wherein the trained machine learning system is a graph neural network (GNN).

Aspect 35. A non-transitory computer-readable medium having stored thereon instructions that, when executed by one or more processors, cause the one or more processors to perform operations according to any of Aspects 18 to 34.

Aspect 36. An apparatus including one or more means for performing operations according to any of Aspects 18 to 34.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus of detecting one or more objects, the apparatus comprising:
at least one memory; and
at least one processor coupled to the at least one memory and configured to:
obtain point cloud data of an environment of the apparatus, the point cloud data comprising one or more point clouds obtained using one or more sensors and a respective field of view of each sensor of the one or more sensors;
obtain, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors;
obtain map data of the environment, the map data comprising one or more spatial priors indicative of at least one of elevated object patterns or locations; and
determine, using a trained machine learning system, a location of an object based on the point cloud data, the camera data, and the map data of the environment of the apparatus.

2. The apparatus of claim 1, wherein the at least one processor is configured to determine the location of the object using the trained machine learning system further based on at least one azimuth, at least one respective radius, and at least one respective elevation of the object with respect to the apparatus.

3. The apparatus of claim 1, wherein the at least one processor is configured to construct a plurality of graphs, wherein a graph of the plurality of graphs is associated with a point cloud of the one or more point clouds and the camera data.

4. The apparatus of claim 3, wherein the graph is further associated with a field of view of a sensor of the one or more sensors used to capture the point cloud and an azimuth, a radius, and an elevation of the object with respect to the apparatus for the point cloud.

5. The apparatus of claim 4, wherein the graph is further associated with a field of view of a camera of the one or more camera sensors.

6. The apparatus of claim 3, wherein each graph of the plurality of graphs comprises a plurality of nodes.

7. The apparatus of claim 6, wherein the at least one processor is configured to prune one or more nodes of the plurality of nodes based on the one or more nodes being at least one of redundant or less informative than other nodes of the plurality of nodes with respect to the object.

8. The apparatus of claim 6, wherein each node of the plurality of nodes includes a first value indicating whether a respective azimuth, a respective radius, and a respective elevation of each node is within the respective field of view of each camera sensor of the one or more camera sensors and a second value indicating whether the respective azimuth, the respective radius, and the respective elevation of each node is within the respective field of view of each sensor of the one or more sensors.

9. The apparatus of claim 3, wherein the at least one processor is configured to process, using the trained machine learning system, the plurality of graphs to determine the location of the object.

10. The apparatus of claim 1, wherein the at least one processor is configured to determine the location of the object further based on temporal data of the environment.

11. The apparatus of claim 1, further comprising the one or more sensors, the one or more sensors configured to capture the one or more point clouds.

12. The apparatus of claim 1, wherein the point cloud data is light detection and ranging (LiDAR) data, and wherein the one or more sensors includes one or more LiDAR sensors.

13. The apparatus of claim 1, further comprising the one or more camera sensors, the one or more camera sensors configured to capture the camera data.

14. The apparatus of claim 1, wherein the apparatus is part of a vehicle.

15. The apparatus of claim 14, wherein the at least one processor is configured to adjust an operating parameter of the vehicle based on the location of the object.

16. The apparatus of claim 15, wherein the operating parameter is associated with at least one of a path for the vehicle to travel, an automatic braking parameter for operating one or more brakes of the vehicle, a lane change parameter for causing the vehicle to navigate from a first lane to a second lane, or a display parameter associated with a user interface of the vehicle.

17. The apparatus of claim 1, wherein the trained machine learning system is a graph neural network (GNN).

18. A method of detecting one or more objects at a device, the method comprising:
obtaining point cloud data of an environment of the device, the point cloud data comprising one or more point clouds obtained using one or more sensors and a respective field of view of each sensor of the one or more sensors;
obtaining, from one or more camera sensors, camera data of the environment, each camera sensor of the one or more camera sensors comprising a respective field of view, wherein a respective vertical field of view of each camera sensor of the one or more camera sensors is greater than a respective vertical field of view of each sensor of the one or more sensors;
obtaining map data of the environment, the map data comprising one or more spatial priors indicative of at least one of elevated object patterns or locations; and
determining, using a trained machine learning system, a location of an object based on the point cloud data, the camera data, and the map data of the environment of the device.

19. The method of claim 18, further comprising constructing a plurality of graphs, wherein a graph of the plurality of graphs is associated with a point cloud of the one or more point clouds and the camera data, a field of view of a sensor of the one or more sensors used to capture the point cloud, an azimuth, a radius, and an elevation of the object with respect to the device for the point cloud, and a field of view of a camera of the one or more camera sensors.

20. The method of claim 19, wherein each graph of the plurality of graphs comprises a plurality of nodes, wherein each node of the plurality of nodes includes a first value indicating whether a respective azimuth, a respective radius, and a respective elevation of each node is within the respective field of view of each camera sensor of the one or more camera sensors and a second value indicating whether the respective azimuth, the respective radius, and the respective elevation of each node is within the respective field of view of each sensor of the one or more sensors.
